(19) United States
(12) Patent Application Publication
(10) Pub. No.: US 2002/0117320 A1
(43) Pub. Date: Aug. 29, 2002

(54) Coil of inductive charging paddle

(76) Inventor: Takashi Hyogo, Kariya-shi (JP)

Correspondence Address: MORGAN & FINNEGAN, L.L.P, 345 Park Avenue, New York, NY, 10154, US

(21) Appl. No.: 10/014,094

(22) Filed: Dec. 11, 2001

(30) Foreign Application Priority Data
Dec. 13, 2000 (JP) 2000-379132

(51) Int. Cl. H01B 1/00

(52) U.S. Cl. 174/68.1

(57) ABSTRACT

An inductive charging paddle includes a core and an electric wire, which is wound about the core to form a coil. The coil is connected to an electricity supplying apparatus through a cable. The electric wire includes a litz wire, a heat-shrinkable tubing, which coats substantially the entire length of the litz wire, and an insulating tube, which coats substantially the entire length of the heat-shrinkable tubing. A space is formed between the heat-shrinkable tubing and the insulating tube. As a result, the structure of the coil is simplified and the flexibility of the electric wire is maintained.

### BACKGROUND OF THE INVENTION

The present invention relates to a coil used in a paddle of an inductive charger for charging a battery of an electric vehicle.

A typical inductive charger for charging electrical vehicle batteries includes a paddle, a receptacle and a power source. The paddle is connected to the power source by a cable. When charging a battery, the paddle is plugged into the receptacle, which is located in the vehicle. The paddle includes a coil for transmitting electricity. The coil is wound about a core, which is located at a part of the paddle that is plugged into the receptacle. The receptacle includes a coil for receiving electricity. The receptacle coil is wound about a core, which is aligned with the paddle core when the paddle is plugged into the receptacle. Alternating current is supplied to a transmitting coil when the paddle is plugged into the receptacle, which induces electricity in the receptacle coil. Accordingly, the vehicle battery is charged.

FIG. 7 is a schematic diagram of a prior art charging paddle 51. The charging paddle 51 has a transmitting coil 53 in a case 52. The transmitting coil 53 is formed by winding an electric wire 55 around a transmitting core 54 four times. The electric wire 55 is made of a litz wire. The litz wire includes approximately one thousand twined and enameled strands, the diameter of each is, for example, 0.1 mm. The enameled strands are fastened by a coating of fine threads. The litz wire is coated by a first insulating tube 56.

The transmitting coil 53 is accommodated in a hollow bobbin 57 (including a bobbin cap). Both ends of the electric wire 55 extend from the transmitting coil 53 and project from a guide portion 57a, which forms an opening on the bobbin 57. The ends of the wire 55, which extend outside the bobbin 57, are each coated by a second insulating tube 58 over the first insulating tube 56. Generally, the wire for a charging paddle must be coated with double insulation to be in compliance with the UL Standard. In addition to the bobbin 57, which covers the transmitting coil 531 the ends of the wire 55, which are exposed outside the bobbin 57, are coated by the second insulating tubes 58. Thus, the UL Standard is met. In this embodiment, the UL Standard that is defined by the Underwriters Laboratories Inc. of U.S.A. is used.

However, the wire 55 is covered with a separate part, or the bobbin 57, to provide double insulation to the wire 55. Therefore, the wire 55 is secured to the bobbin 57 and then the bobbin 57 is secured to the case 52. This complicates the structure of the paddle 51 and the assembling procedure. Furthermore, in this type of charging paddle 51, the wire 55 is wound about the bobbin 57. Thus, the wire 55 must also be flexible.

### SUMMARY OF THE INVENTION

Accordingly, it is an objective of the present invention to provide a simplified coil used in a charging paddle. A further objective of the present invention is to improve the flexibility of an electric wire that forms the coil.

To achieve the foregoing objective, the present invention provides a coil used in an inductive charging paddle. A core is located in the paddle. An electric wire is wound about the core to form the coil. The coil is connected to a power source through a cable. The electric wire includes a core wire and a plurality of insulating members for multi-coating the core wire.

The present invention also provides a coil used in an inductive charging paddle. A core is located in the paddle. An electric wire is wound about the core to form the coil. The coil is connected to a power source through a cable. The electric wire includes a litz wire, a first insulating tube, and a second insulating tube. The litz wire is made of bundles of strands. The first insulating tube coats substantially the entire length of the litz wire. The second insulating tube coats substantially the entire length of the first insulating tube.

The present invention further provides a coil used in an inductive charging paddle. A core is located in the paddle and an electric wire is wound about the core to form the coil. The coil is connected to a power source through a cable. The electric wire includes a pair of parallel litz wires, a pair of first insulating tube, and a single second insulating tube. Each litz wire is made of bundles of strands. Each first insulating tube coats substantially the entire length of one of the litz wires. The single second insulating tube coats substantially the entire length of both of the first insulating tubes.

A further aspect of the present invention is to provide an inductive charging paddle. The inductive charging paddle includes a core and an electric wire. The electric wire is wound about the core to form a coil. The coil is connected to a power source through a cable. The electric wire includes a core wire, a first insulating member, and a second insulating member. The first insulating member coats the core wire. The second insulating member coats the first insulating member.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a charging paddle according to a first embodiment of the present invention;

FIG. 2 is a cross-sectional view taken along line 2-2 in FIG. 1;

FIG. 3(a) is a side view illustrating an electric wire that forms a transmitting coil in the paddle of FIG. 1;

FIG. 3(b) is a cross-sectional view taken along line 3(b)-3(b) in FIG. 3(a).

FIG. 4 is a perspective view illustrating an inductive charger that uses the paddle in FIG. 1;

FIG. 5 is a cross-sectional view taken along line 5-5 in FIG. 6 illustrating a charging paddle according to a second embodiment of the present invention;

FIG. 6 is an enlarged partial cross-sectional view illustrating the charging paddle according to the second embodiment; and

FIG. 7 is a cross-sectional view illustrating a charging paddle according to a prior art.

### DETAILED DESCRIPTION OF THE PREFERRED EMBODIMENTS

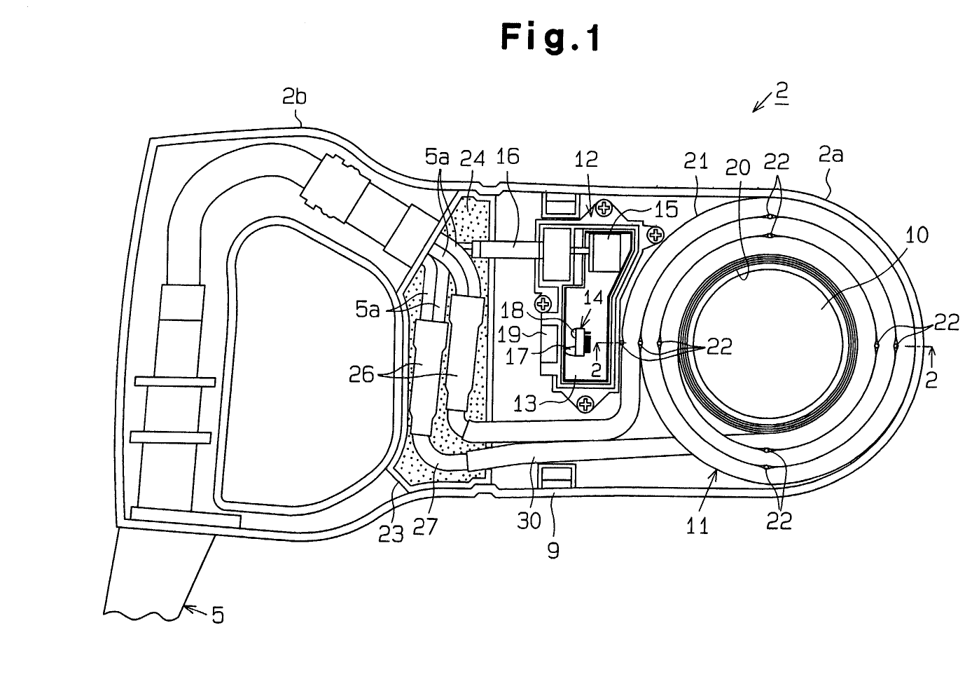

A first embodiment of the present invention will now be described with reference to FIGS. 1 to 4.

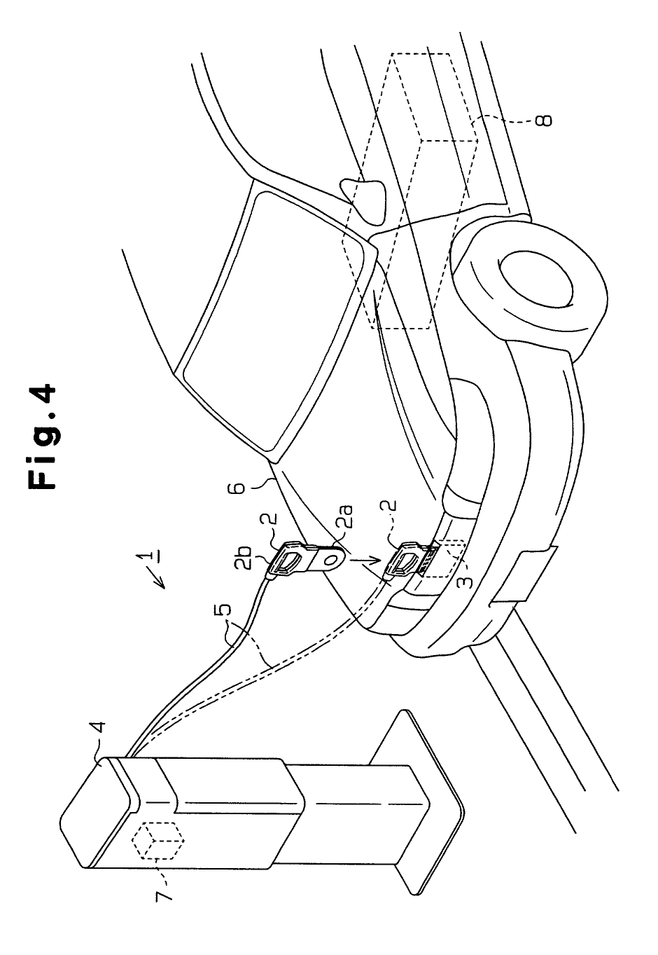

As shown in FIG. 4, an inductive charger 1 includes a charging paddle 2, a receptacle 3 and a power source 4. The paddle 2 is connected to the power source 4 by a cable 5. The charging paddle 2 and the receptacle 3 form a charger coupling. The receptacle 3 is located in a predetermined position in a vehicle 6 and is connected to a vehicle battery 8. In this embodiment, the receptacle 3 is located in front of the hood. When charging the battery 8, the paddle 2 is plugged into the receptacle 3. The charging paddle 2 and the power source 4 form an electricity supplying apparatus.

The power source 4 includes a controller 7. The controller 7 controls alternating current supplied to the paddle 2 based on signals wirelessly transmitted between the paddle 2 and the receptacle 3. The signals include an interlock release signal, which indicates that the paddle 2 is completely plugged into the receptacle 3, and a voltage level signal, which indicates the charging level of the battery 8.

FIG. 1 is a cross-sectional view illustrating the charging paddle 2. The charging paddle 2 includes a case 9, a cylindrical transmitting core 10, an annular transmitting coil 11 and a communication control unit 12. The case 9 includes a plug portion 2a and a grip 2b. The plug portion 2a is plugged into the receptacle 3 (see FIG. 4). The transmitting core 10 is incorporated at the distal end of the plug portion 2a. The transmitting coil 11 is located about the transmitting core 10. The control unit 12 is located at the center of the case 9. The case 9 is made of an insulative infrared-transparent resin. The infrared signal communication is performed between the control unit 12 and an infrared transmitter-receiver (not shown) of the receptacle 3.

The control unit 12 includes an infrared transmitter-receiver 14 and a communication circuit 15, which are located on a substrate 13. The communication circuit 15 controls the infrared transmitter-receiver 14. The communication circuit 15 has a main control circuit, a filter circuit for reducing noise in signals form the controller 7, and an amplifier for amplifying signals from the controller 7. A signal line 16 extends through the cable 5 to connect the communication circuit 15 with the controller 7 in the power source 4. The infrared transmitter-receiver 14 includes a luminous element 17 and a photodetector 18. The luminous element 17 emits an infrared light signal based on a control signal from the communication circuit 15. The photodetector 18 receives an infrared light signal from the infrared transmitter-receiver of the receptacle 3. In the first embodiment, the infrared communication type is based on the IrDA Standard.

A prism 19 is located on the substrate 13. An infrared light signal from the luminous element 17 is refracted in two opposite directions (both of which are perpendicular to the surface of the sheet of FIG. 1) by the prism 19. One of the refracted signals is received by the infrared transmitter-receiver of the receptacle 3. The photodetector 18 receives an infrared light signal from the infrared transmitter-receiver of the receptacle 3 through the prism 19. The prism 19 permits the paddle 2 and the receptacle 3 to communicate regardless of which side of the paddle 2 faces the transmitter-receiver of the receptacle 3. Therefore, the paddle 2 needs only one transmitter-receiver 14. Instead of infrared, the paddle 2 and the receptacle 3 may exchange radio waves through antennas. Also, the paddle 2 and the receptacle 3 may include both infrared transmitter-receiver and radio antennas.

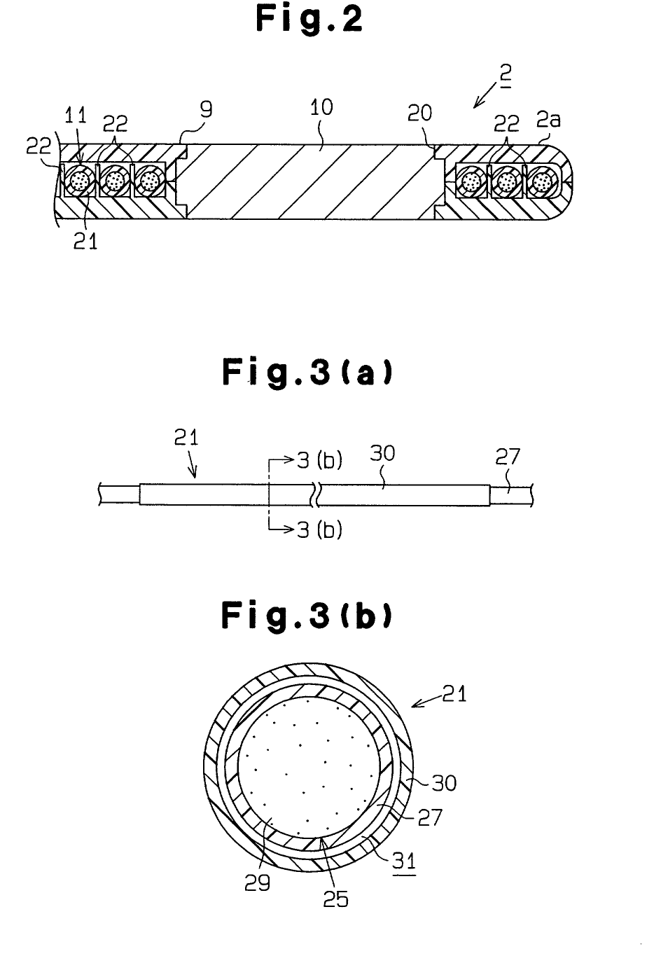

As shown in FIGS. 1 and 2, a substantially circular opening 20 is formed at the plug portion 2a of the case 9. The transmitting core 10 is fitted in the opening 20. The transmitting coil 11 is accommodated in the case 9 about the core 10. The transmitting coil 11 is formed by winding an electric wire 21 around the transmitting core 10. Guide pins 22, which serve as positioners, are formed on the inner surface of the case 9. The electric wire 21 is guided by each guide pin 22 and wound about the transmitting core 10, for example, three times. The windings of the wire 21 are generally radially arranged. Each guide pin 22 determines the position of the electric wire 21 in the case 9.

As shown in FIG. 1, an annular container 23 is formed at substantial center of the case 9. The container 23 and the inner surface of the case 9 define a noise suppressing chamber 24. The surface of the noise suppressing chamber 24 is coated by plating. The plating layer absorbs noise emitted from the electric wire 21 or the transmitting coil 11. Two ends of the electric wire 21, which extend from the transmitting coil 11, are connected to power lines 5a, which extend from the cable 5, in the noise suppressing chamber 24. The power lines 5a are connected to the power source 4 through the cable 5. Each end of the electric wire 21 is connected to two power lines 5a. The connecting portion of each end of the electric wire 21 and the corresponding power lines 5a is covered by a water-proof material 26 to protect a litz wire 25 (see FIG. 3(b)) in the electric wire 21 from being wet.

As shown in FIGS. 3(a) and 3(b), the electric wire 21 includes a litz wire 25, a heat-shrinkable tubing 27, and an insulating tube 30. The heat-shrinkable tubing 27 coats the litz wire 25, which is a core wire. The litz wire 25 includes about one thousand twisted, enameled strands 29. The diameter of each enameled strand 29 is about 0.1 mm. Specifically, the litz wire 25 includes bundles of the enameled strands 29. The number of the bundles is twenty in this embodiment. Each bundle has tens of enameled strands 29. In this embodiment, each bundle has about fifty strands 29. The litz wire 25 is held together and protected by the tubing 27. This prevents the enameled strands 29 from rubbing against each other.

The electric wire 21 has double insulation formed by covering the litz wire 25 with the heat-shrinkable tubing 27, which is a first insulating member, and the insulating tube 30, which is a second insulating member. In other words, the heat-shrinkable tubing 27 and the insulating tube 30 form a multiple coating (multi-coating) of the litz wire 25. A space 31 is provided between the inner surface of the insulating tube 30 and the outer surface of the heat-shrinkable tubing 27. The insulating tube 30 is formed by a flame-resistant and heat-resistant material. The litz wire 25 is covered by the heat-shrinkable tubing 27 and the insulating tube 30 along its entire length except its ends. The ends of the insulating tube 30 is located in the noise suppressing chamber 24 after the electric wire 21 is wound about the transmitting core 10. The flexibility of the electric wire 21 improved by the space 31 between the heat-shrinkable tubing 27 and the insulating tube 30.

The illustrated embodiment has the following advantages.

As described in the BACKGROUND OF THE INVENTION section, the electric wire 21 must have double insulation to be in compliance with the UL Standard. In this embodiment, to provide double insulation, the litz wire 25 is coated by the heat-shrinkable tubing 27 and the insulating tube 30. Therefore, the prior art bobbin is unnecessary and the transmitting coil 11 is simplified. Accordingly, number of processes required to install the transmitting coil 11 is reduced, which simplifies installing procedure.

The space 31 is provided between the heat-shrinkable tubing 27 and the insulating tube 30. Therefore, the electric wire 21 is flexible and easily wound about the transmitting core 10.

The guide pins 22 are arranged on the inner surface of the case 9 to position and fix the electric wire 21. Therefore, the electric wire 21 is positioned and fixed in the case 9 without a bobbin.

The litz wire 25, which includes twisted, enameled strands 29, is coated with the heat-shrinkable tubing 27. Thus, the enameled strands 29 are tightly held by the heat-shrinkable tubing 27 such that there is no space between each enameled strand 29. Therefore, even when vibration occurs while using the charging paddle 2, the enameled strands 29 are prevented from rubbing against each other. As a result, removal of insulation coating of the enameled strands 29 is reduced, which reduces a short circuit.

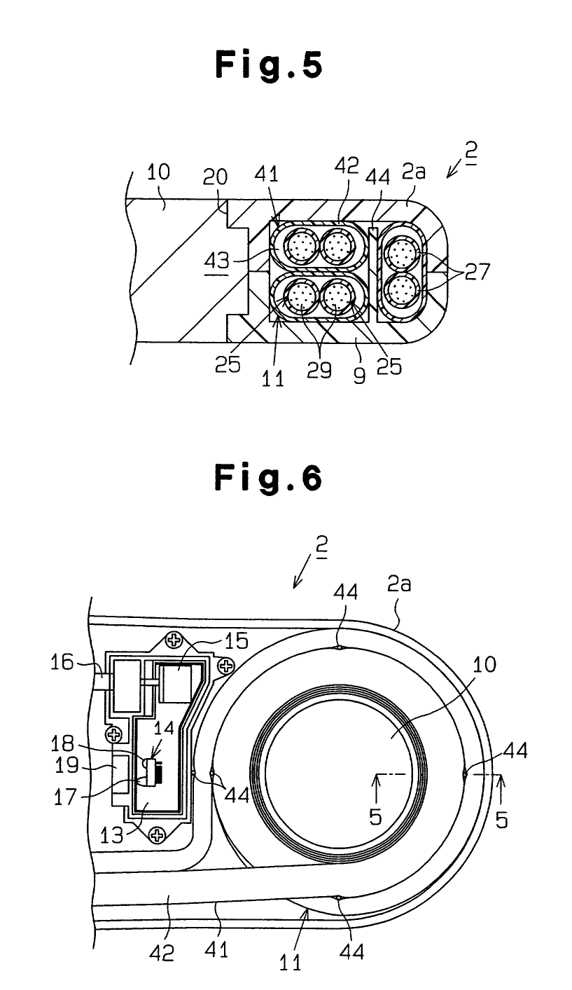

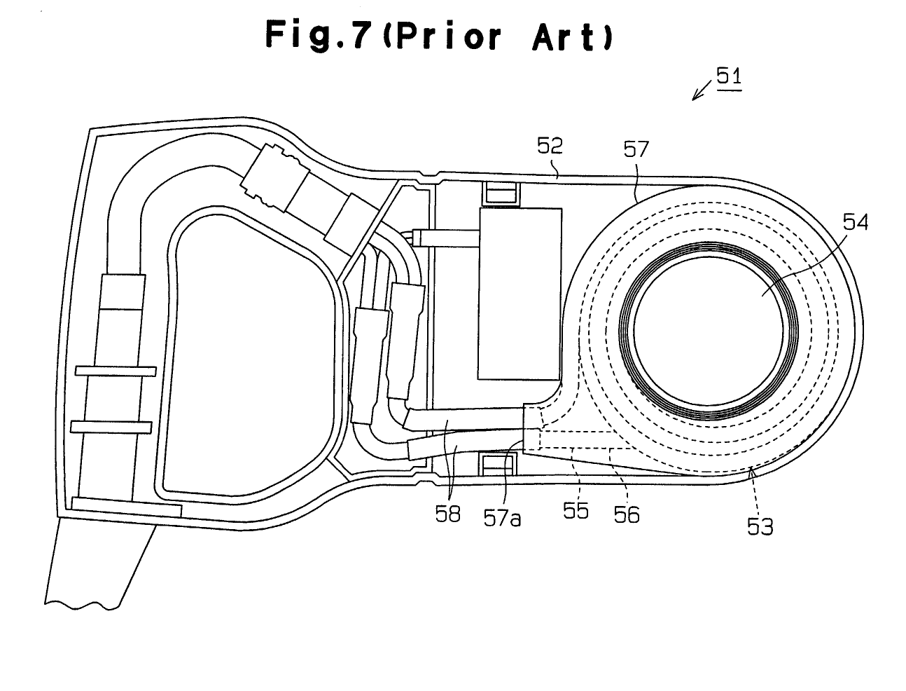

A second embodiment will now be described with reference to FIGS. 5 and 6. In the second embodiment, the differences from the first embodiment, which is shown in FIGS. 1 to 4, will be discussed in detail below.

In the second embodiment, an electric wire 41, which forms the transmitting coil 11, is different from the electric wire 21 of the first embodiment shown in FIGS. 1 to 4. That is, as shown in FIG. 5, the electric wire 41 includes two parallel litz wires 25, each of which is coated by a heat-shrinkable tubing 27, and an insulating tube 42, which covers the litz wires 25. Since the litz wires 25 are arranged in parallel to each other, the electric wire 41 is flat. A predetermined space 43 is formed between the inner surface of the insulating tube 42 and the set of the heat-shrinkable tubings 27. The end of each litz wire 25 is connected to one of the power lines 5a (see FIG. 1). The heat-shrinkable tubing 27 is a first insulating member and the insulating tube 42 is a second insulating member.

As shown in FIGS. 5 and 6, guide pins 44, which serve as positioners, are formed on the inner surface of the case 9. The electric wire 41 is guided by the guide pins 44 and wound about the transmitting core 10, for example, three times. More specifically, two of the windings of the wire 41 that form a radially inner portion of the coil 11 are arranged to form two layers in the axial direction of the coil 11, and one of the windings of the wire 41 are located around the two windings. The portion of the wire 41 that forms the two windings lies horizontally with respect to a plane perpendicular to the axis of the coil 11. The portion of the wire 41 that forms the outer winding lies vertically with respect to the plane perpendicular to the axis of the coil 11. The guide pins 44 determines the positions of the windings of the electric wire 41 with respect to the case 9.

In the second embodiment, the following advantages are provided in addition to the advantages of the first embodiment.

Two litz wires 25 are accommodated in the single insulating tube 42. The four ends of the litz wires 25 are each connected to one of the four power lines 5a. In comparison to a case when each end of the litz wire 25 is connected to two of the four power lines 5a as described in the first embodiment, the joint portions of the electric wires 41 and the power lines 5a are simplified. Also, water-proof material 26 (see FIG. 1) is applied to each joint portion between one end of the electric wire 41 and the corresponding power lines 5a to prevent water from entering each joint portion. This increases water-resistance of the joint portions.

When winding the electric wire 41 to the transmitting core 10, the electric wire 41 is wound about the transmitting core 10 three times in total. That is, the electric wire 41 is laid horizontally and wound about the transmitting core 10 twice to form two layers and then held vertically and wound about the two layers once. Therefore, the electric wire 41 is efficiently wound about the transmitting core 10 and the size of the transmitting coil 11 is reduced.

It should be apparent to those skilled in the art that the present invention may be embodied in many other specific forms without departing from the spirit or scope of the invention. Particularly, it should be understood that the invention may be embodied in the following forms.

In each of the illustrated embodiments, the space 31, 43 does not have to be formed. The transmitting coil 11 may be formed using an electric wire that has no space between the heat-shrinkable tubing 27 and the insulating tube 30, 42.

In each of the illustrated embodiments, the space 31, 43 is appropriately determined. That is, when winding the electric wire 21, 41 to the transmitting core 10, the size of the space may be arbitrarily determined as long as the flexibility of the electric wire 21, 41 is maintained.

In each of the illustrated embodiments, the first insulating material that coats the litz wire 25 may not be the heat-shrinking tubing 27. The first insulating material may be the same material as the second insulating material 30, 42.

In each of the illustrated embodiments, the electric wire 21, 41 does not have to be coated with double insulation. The electric wire 21, 41 may be coated with, for example, multi-insulation having three or more layers.

In each of the illustrated embodiments, the electric wire 21, 41 does not have to be positioned and fixed with the guide pins 22, 44. For example, the electric wire 21, 41 may be fixed on the inner surface of the case 9 with adhesives.

The heat-shrinkable tubing 27 is made of polyurethane in each of the illustrated embodiments. However, the heat-shrinking tubing 27 may be made of other heat-shrinkable resin such as polyolefin, polyethylene terephthalate, or polyvinyl chloride.

The number of the enameled strands 29 is not limited to about one thousand as long as the number is sufficient for charging. The electric wire 21, 41 may be one lead wire instead of litz wire 25.

In the first embodiment, the windings of the electric wire 21 are radially arranged. However, the windings of the electric wire 21 may be axially arranged. Also, the electric wire 21 may be wound about the transmitting core 10 four times or more.

In each of the illustrated embodiments, the shape of the paddle 2 may be changed. For example, the paddle 2 may be shaped like a gun.

Therefore, the present examples and embodiments are to be considered as illustrative and not restrictive and the invention is not to be limited to the details given herein, but may be modified within the scope and equivalence of the appended claims.

What is claimed is:

1. A coil used in an inductive charging paddle, wherein a core is located in the paddle, and an electric wire is wound about the core to form the coil, and wherein the coil is connected to a power source through a cable, the electric wire comprising:
a core wire; and
a plurality of insulating members for multi-coating the core wire.

2. The coil according to claim 1, wherein the insulating members include at least a first insulating member, which directly coats the core wire, and a second insulating member, which coats the first insulating member, wherein a space is provided between the first insulating member and the second insulating member.

3. The coil according to claim 1, wherein the insulating members include a first insulating member, which is made of heat-shrinkable material and directly coats the core wire, and wherein the first insulating member is heat shrunk for holding the core wire.

4. The coil according to claim 3, wherein the core wire is a litz wire, which is made of bundles of strands.

5. The coil according to claim 3, wherein the insulating members include a second insulating member, which coats the first insulating member, wherein a space is provided between the first insulating member and the second insulating member.

6. The coil according to claim 1, wherein the coil is accommodated in a case of the paddle, wherein the case includes a positioner for determining the position of the electric wire that is wound about the core.

7. The coil according to claim 1, wherein each insulating member is a tube, which coats substantially the entire length of the core wire.

8. The coil according to claim 1, wherein the electric wire is wound a plurality of times to form windings and the windings are generally radially arranged.

9. The coil according to claim 1, wherein the core wire is one of a pair of core wires, wherein the insulating members include a pair of first insulating members, each of which coats one of the core wires, and a single second insulating member, which coats both of the first insulating members.

10. The coil according to claim 9, wherein the core wires extend parallel to each other such that the electric wire is flat.

11. The coil according to claim 10, wherein the electric wire is wound three times to form three windings, wherein two of the windings are arranged to form two layers in the axial direction of the coil, and the remaining one of the windings is located around the two windings, wherein the portion of the electric wire that forms the two windings lies horizontally with respect to a plane perpendicular to the axis of the coil, and the portion of the electric wire that forms the outer winding lies vertically with respect to the plane.

12. A coil used in an inductive charging paddle, wherein a core is located in the paddle, and an electric wire is wound about the core to form the coil, and wherein the coil is connected to a power source through a cable, the electric wire comprising:
a litz wire, which is made of bundles of strands;
a first insulating tube, which coats substantially the entire length of the litz wire; and
a second insulating tube, which coats substantially the entire length of the first insulating tube.

13. The coil according to claim 12, wherein a space is provided between the first insulating tube and the second insulating tube.

14. The coil according to claim 12, wherein the first insulating tube is made of a heat-shrinkable material, and wherein the first insulating tube is heat shrunk for holding the litz wire.

15. The coil according to claim 12, wherein the coil is accommodated in a case of the paddle, wherein the case includes a positioner for determining the position of the electric wire that is wound about the core.

16. A coil used in an inductive charging paddle, wherein a core is located in the paddle, and an electric wire is wound about the core to form the coil, and wherein the coil is connected to a power source through a cable, the electric wire comprising:
a pair of parallel litz wires, wherein each litz wire is made of bundles of strands;
a pair of first insulating tube, wherein each first insulating tube coats substantially the entire length of one of the litz wires; and
a single second insulating tube, which coats substantially the entire length of both of the first insulating tubes.

17. The coil according to claim 16, wherein the electric wire is flat, and the electric wire is wound three times to form three windings, wherein two of the windings are arranged to form two layers in the axial direction of the coil, and the remaining one of the windings is located around the two windings, wherein the portion of the electric wire that forms the two windings lies horizontally with respect to a plane perpendicular to the axis of the coil, and the portion of the electric wire that forms the outer winding lies vertically with respect to the plane.

18. An inductive charging paddle comprising:
a core; and
an electric wire, which is wound about the core to form a coil, wherein the coil is connected to a power source through a cable, and the electric wire includes:
a core wire;
a first insulating member, which coats the core wire; and
a second insulating member, which coats the first insulating member.
